(19) United States
(12) Patent Application Publication
(10) Pub. No.: US 2013/0048186 A1
(43) Pub. Date: Feb. 28, 2013

(54) Method For Manufacturing A Decorative Arrangement Using Spanish Moss

(71) Applicant: Mark Boyce Wickham, DeLeon Springs, FL (US)

(72) Inventor: Mark Boyce Wickham, DeLeon Springs, FL (US)

(21) Appl. No.: 13/222,654

(22) Filed: Aug. 31, 2011

(51) Int. Cl. B32B 37/12; B32B 37/14

(52) U.S. Cl. 156/60

(57) ABSTRACT

A method is disclosed for treating Spanish moss and for creating a decorative arrangement of the moss. Spanish moss is collected, treated with a pesticide, if necessary, and dried to remove substantially all moisture. The dried moss is separated into strands and draped over a cord that has been pre-treated with an adhesive binder to cause the strands of moss to adhere to the cord and create a continuous layer of moss over the length of the cord. The strands are then sprayed with adhesive that covers the strands and provides a binder that supports the strands and prevents the dried moss from deterioration. The adhesive covered layer of moss is then dried until the adhesive binder has set and is no longer tacky to the touch. Predetermined lengths of the layers of moss are then packaged for retail sale.

### BACKGROUND OF THE INVENTION

The present invention relates to method for producing a garland or decorative arrangement using Spanish moss and, more particularly, for making a decorative arrangement using such moss to create a spooky appearance for Halloween.

Spanish moss (Tillandsia usneoides) is a flowering plant that grows upon larger trees, commonly the Southern Live Oak or Bald Cypress throughout the southeastern United States and also in Mexico and in Hawaii. The plant has slender stems with thin, curved or curly, heavily scaled leaves that range between 0.5 and 2.5 inches in length and are about 0.04 inches in width so that they appear as string-like cords of a grayish green color when live. The leaves and stems grow in chain-like fashion to form hanging structures up to 20 feet in length. The individual leaves and stems tend to be fragile and break away in fragments that blow on the wind and stick to other trees and limbs where they grow into new hanging structures. Birds have also been known to collect Spanish moss to create nests which further spreads the moss into new locations.

The elongate stems and leaves of Spanish moss tend to intertwine and create a structure that is often home for a number of creatures, including rat snakes, bats and insects. Spiders are common in moss structures as are redbugs, or chiggers, the latter being a source of an unpleasant, itching rash on the skin if the plants are handled. Spanish-moss was harvested for years as a stuffing material in automobile seats, furniture, and mattresses. The plants were dried and cured before being used.

It is known to use Spanish moss to create a spooky mood by hanging such moss so as to simulate the appearance of spider webs and other items that often collect in deserted houses or other buildings and in outdoor areas. However, because Spanish moss is a live parasite that is often the home for other insects, such as spiders and chiggers, the moss must be treated before use. Another problem with using Spanish moss for decoration is that the moss rapidly begins to die and deteriorate when taken from its host, such as oak trees. As the Spanish moss dies, it begins to break into small pieces in response to any disturbance thus creating a messy environment. However, it is desirable to dry and cure the moss before use to eliminate the insects in the moss thus enhancing the detrimental breakage of the moss stems and leaves.

### SUMMARY OF THE INVENTION

The present invention provides a method for treating Spanish moss and for creating a decorative arrangement that overcomes the disadvantages discussed above. Spanish moss that is collected from its natural environment can be treated, if necessary, with a pesticide to destroy any live insects that may be found in the moss. The moss is then dried so that it is no longer living. The dried moss is then separated into strands and draped over a cord that has been pre-treated with an adhesive binder. The adhesive binder causes the strands to adhere to the cord and creates a continuous layer of moss over the length of the cord. The strands are then sprayed with another adhesive that covers the strands and provides a binder that supports the strands and prevents the dead moss from further deterioration. The layers of moss are then allowed to dry for a further period so that the adhesive binder sets and is no longer tacky to the touch. Predetermined lengths of the layers of moss are then packaged for retail sale.

### BRIEF DESCRIPTION OF THE DRAWINGS

For a better understanding of the present invention, reference is made to the following detailed description taken in conjunction with the accompanying drawings in which:

FIG. 1 is a view of a decorative arrangement or garland of Spanish moss in a form in which it would be applied for use as a decoration; and

FIG. 2 is a block diagram illustrating a preferred method of producing the garland of FIG. 1.

### DETAILED DESCRIPTION

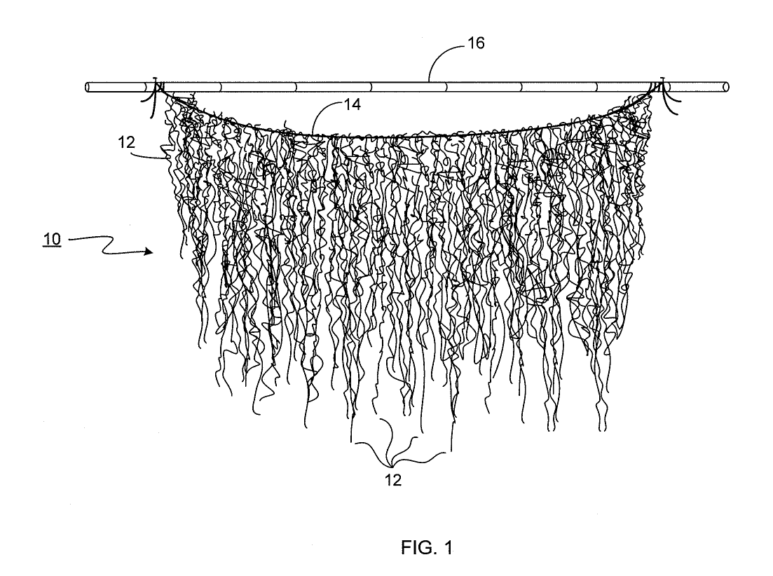

Referring to FIG. 1, there is shown a decorative arrangement 10 of Spanish moss produced in accordance with the teaching of the present invention. As shown in this figure, the moss has been separated into strands 12 and a plurality (or a group) of such strands are draped over a support, preferrably a cord or string 14 of either natural or man-made fibers having flexibility so that the decoration can be rolled for packaging and storage and easily unpacked for decorating by draping across an opening such as a window or doorway. The strands 12 are created by pulling the moss stems and leaves apart to separate the intertwined bunches into smaller segments typically about five inches in width and about three to four feet in length. Such strands are about one to two inches in thickness and can either be laid flat or hung over a support for drying. The cord 14 has extended ends to allow the decorative arrangement to be affixed at each end using tacks or tape or other fasteners. During the manufacturing process, the arrangement 10 is supported on a pole 16 as will be described hereinafter.

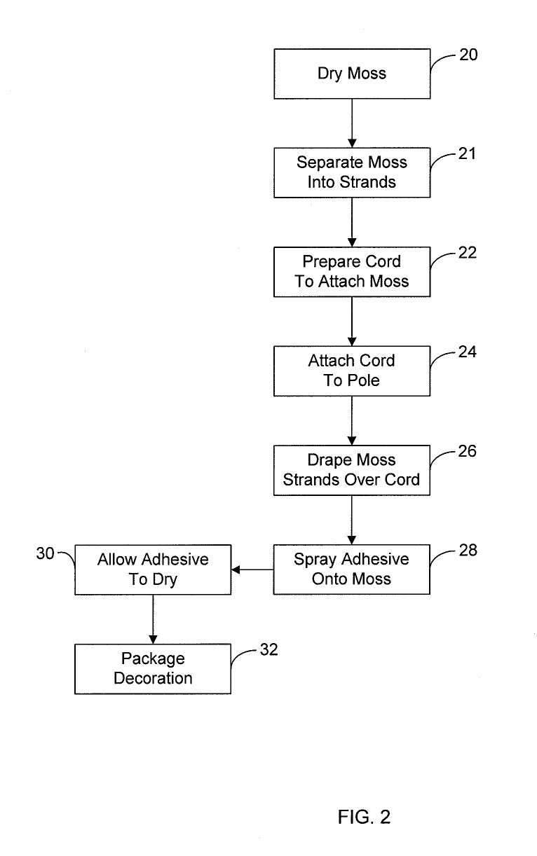

Turning now to FIG. 2, there is shown a preferred process in block diagram form for creating the decorative arrangement of FIG. 1. The first step, after obtaining a supply of Spanish moss, is to dry the moss, block 20, until all of the green tinge has disappeared so that there is no live portion of the moss remaining. The drying process is necessary to prevent growth of algae on the moss if the moisture content is not sufficiently reduced and to avoid “rotting” of the moss when packaged. Applicants have found that drying the moss in a kiln at about 160 degrees Fahrenheit for about eight hours is sufficient to remove moisture and to eliminate any pests habitant in the moss. It is also possible to sun dry the moss if protected from rain but such process can take up to 18 days or more depending on relative humidity. Sun drying may not kill any insects in the moss and may require use of an insecticide treatment. Further, for sun drying, the moss must be spread onto a protective supporting sheet such as a plastic or fabric tarpaulin and therefore requires a large outdoor, unobstructed area. Once the moss has dried, it can be colored using a dye spray or submersion if desired but then requires additional drying time for the dye liquid to dry.

After drying the moss, it is now ready to be separated into long strands that can be draped over the cord 14, block 21. The preferred method of separation of the moss into strands is to manually pull the moss apart. As discussed above, Spanish moss grows with a stem from which a leaf structure extends. Both the stem and leaf structure are structurally weak. Typically, the plant consists of a slender stem bearing alternate thin, curved or curly, heavily scaled leaves 2-6 cm long and 1 mm broad that grow in chain-like fashion (pendant) to form hanging structures up to 6 m in length. The moss stem is not much larger in cross section than the leaves. Leaves from adjacent stems tend to intertwine and cause the moss to hang from trees in globular masses. The process of separating the moss into strands involves manually pulling the masses apart until a reasonable size segment or strand of moss results.

In block 22, the cord 14 is prepared by applying an adhesive binder to the cord. The preferred method is to pass the cord through a container containing the adhesive. Applicants use a 3-ply jute twine for the cord 14 and a latex adhesive such as a Hycar brand binder available under their model number 26349. One method for coating the cord with the adhesive is to partially fill a container with the adhesive, submerge a metal rod or other retainer in the adhesive, and then pass the end of the cord into the container and under the retainer so that as the cord is pulled through the container, it becomes saturated with the adhesive. The cord 14 is then cut to a desired length using any conventional cutting mechanism and then stretched across an elongate support, block 24.

The support may be any type of pole such as bamboo rod 16 to which the cord 14 can be attached. In a preferred form, a single pole is be used for each cord 14 with the cord attached to the pole at opposite ends. A hook, screw or other feature may be fastened adjacent ends of the pole to provide an easy connection point for the ends of the cord. The advantage of using the single pole is that each of the decorative arrangements can be individually handled rather than having a plurality of the arrangements 10 that must be processed together. For example, since each arrangement must be individually created by draping the separated strands 12 of moss over the cord 14, block 26, having a separate pole for each arrangement allows a worker to position the pole in a convenient position for placing the moss on the cord. As stated in block 26, the worker separates the dried moss into long strands and then hangs or drapes the strands over the adhesive soaked cord 14 in adjacent positions to create the arrangement as shown in FIG. 1. It will be appreciated that the moss strands are placed on the cord 14 before the adhesive has dried so that the moss will bond to the cord via the adhesive. It is desirable to press the moss into the adhesive to assure sufficient bonding of the moss to the cord 14. With the single pole method described above, once the cord has been covered with the moss, the pole can then be placed on a support rack, not shown, awaiting the next step in the process.

As previously discussed, one problem with handling of Spanish moss is its brittleness that causes constant breakage of small pieces of moss, particularly after the moss is no longer alive and has been dried to a low moisture content. In order to overcome this problem, the decorative arrangements 10 are next processed by applying a spray coating of an adhesive binder to the arrangements, block 28. The binder may be applied in a conventional type of spray or paint booth or, if the weather permits, in an outdoor environment. In a preferred embodiment, the decorative arrangements 10 are processed through a spray booth that assures relatively even coating of the moss with the adhesive binder. In the spray booth, not shown, a pair of pneumatic spray guns direct a diluted adhesive onto both sides of each arrangement 10. The adhesive may be the same adhesive identified above for coating of the cord 14 but diluted enough to be applied via the spray guns. If necessary to assure even coating, additional spray guns may be used in the booth with all of the spray guns being fixed in position and remotely actuated. Alternatively, a mechanical sensor or an electronic sensor may be used to sense the presence of an arrangement 10 in the spray booth and actuate the spray guns. The decorative arrangements 10 may be advanced through the spray booth using any conventional type of mechanism common to automated spray booths. Such a mechanism allows a series of arrangements or garlands to be sequentially passed through the spray booth for production purposes.

In the present invention, the decorative arrangement or garland 10 is hung from overhead hooks or hangers (not shown) using the pole 16. The overhead hangers are part of a conventional mechanism such as a circulating chain conveyer that advances the hangers into and through the spray booth. The aforementioned spray guns are coupled to a pressurized tank of Hycar adhesive and are actuated by detection of a leading edge of a garland 10 entering the spray booth. After the garland is sprayed with the adhesive, the conveyer advances it out of the spray booth where it is removed from the overhead hangers and placed on a drying rack, block 30. It has been found that the adhesive covering the moss is sufficiently dry within about 24 hours to allow the garland 10 to be removed from the pole 16 and prepared for packaging, block 30.

It is desirable to package the garland 10, block 32, in a minimum size package in order to reduce shelf space requirements in a retail outlet. However, it has been found that simply rolling up or folding the garland results in the overlapping strands becoming entangled with each other and causes undue breakage when separated by a user. In order to prevent such entangling, applicant lays out the garland on a surface and covers the garland with tissue paper. The garland can then be rolled with the tissue paper separating the overlapping layers. The rolled garland can then be inserted into a bag. It has been found that use of the tissue paper also reduces breakage of the individual stems and leaves of the moss. Preferably, the bag is a conventional type of plastic package that can be heat sealed for moisture protection. Various methods are known in the art for inserting the rolled garland into the bag and applicant has found that the use of a simple chute is effective for this purpose.

1. A method for making a decorative garland using Spanish moss harvested from trees comprising:
collecting live moss from trees;
drying the moss until substantially all moisture has been evacuated from the moss;
separating the moss into a plurality of elongate strands;
draping the strands of moss over a cord coated with a first adhesive binder so as to bind the strands of moss to the cord until sufficient strands have been attached to the cord to form a generally rectangular garland of predetermined dimension;
spraying the formed garland of moss with a second adhesive binder to strengthen the moss strands and minimize breakage of individual strands; and
drying the second adhesive binder to complete the decorative garland.

2. The method of claim 1 and including the further step of pressing the strands of moss into the first adhesive binder on the cord.

3. The method of claim 1 wherein the step of drying the moss includes the step of placing the moss into a kiln for a predetermined time period and at a temperature sufficient to dry the moss and kill insects resident therein.

4. The method of claim 3 wherein the temperature of the kiln is set at about 160 degrees Fahrenheit.

5. The method of claim 4 wherein the predetermined time is at least eight hours.

6. The method of claim 1 wherein the step of drying the moss includes the step of spreading the moss onto a supporting sheet in a location exposed to sunlight until the moss has dried.

7. The method of claim 6 and including the step of spraying the moss with an insecticide.

8. The method of claim 1 and including the step of spraying the moss after drying with a dye to adjust the moss color.

9. The method of claim 8 and including the step of drying the moss for an additional period to allow the dye to set.

10. The method of claim 1 and including the step of fastening each end of the cord to opposite ends of a support pole prior to draping the moss strands over the cord.

11. The method of claim 10 wherein the step of spraying the moss with the second adhesive binder comprises the step of passing the moss garland through a spray booth and spraying both sides of the garland with the second adhesive binder concurrently.

12. The method of claim 11 and including the further step of air drying the adhesive coated moss garland while supported on the pole.

13. The method of claim 12 and including the further steps of removing the moss garland from the pole, laying the garland on a generally flat surface and covering the garland with a protective sheet of tissue paper.

14. The method of claim 13 and including the further steps of rolling the moss garland such that all overlapping layers of moss are separated by the tissue paper and inserting the rolled garland into a sealable bag.

15. A method of making a decorative garland from Spanish moss comprising the steps of:
collecting a supply of live Spanish moss;
drying the moss in a kiln at temperature of about 160 degrees Fahrenheit for about eight hours to substantially remove all moisture from the moss;
separating the moss into a plurality of strands with each strand having a width of about five inches and a length of about three feet;
preparing a multiply cord of about five feet in length by dipping the cord into an-a first adhesive binder until the cord is saturated with the first adhesive binder;
stringing the cord along the length of a support pole by affixing opposite ends of the cord to the pole;
sequentially draping ones of the groups of moss strands over the cord so as to form a substantially rectangular curtain of moss handing from the cord;
spraying an-a second adhesive binder onto both sides of the curtain of moss until all surfaces of the moss are substantially covered with the second adhesive binder;
supporting the pole and moss curtain for a length of time sufficient to allow the second adhesive binder to fully dry; and
remove the cord from the pole with the attached moss curtain and placing the moss curtain in a sealable package for shipment.

16. The method of claim 15 wherein the first adhesive binder is a latex adhesive binder.

17. The method of claim 15 and including the step of pressing the groups of moss strands into contact with the adhesive soaked cord during the step of draping the moss over the cord.

18. The method of claim 15 and including the step of coloring the dried moss with a dye prior to the step of draping the moss over the cord.

19. The method of claim 18 and including the step of drying the colored moss in a kiln.

20. The method of claim 19 wherein the step of coloring the moss comprises the step of dipping the moss into a dye to achieve the coloring of all surfaces of the moss.
